(19) United States
(12) Patent Application Publication
(10) Pub. No.: US 2004/0193497 A1
(43) Pub. Date: Sep. 30, 2004

(54) Pos system having time-of-consumption management function of sales commodities

(76) Inventor: Eiichi Tanaka, Tokyo (JP)

Correspondence Address: Kanesaka & Takeuchi, Suite 2, 1423 Powhatan Street, Alexandria, VA, 22314, US

(21) Appl. No.: 10/485,144

(22) PCT Filed: Aug. 21, 2002
(86) PCT No.: PCT/JP02/08434

(30) Foreign Application Priority Data
Aug. 24, 2001 (JP) 2001-253984

(51) Int. Cl. G06F 17/60

(52) U.S. Cl. 705/16

(57) ABSTRACT

To provide a POS system so designed that where a commodity whose the time of consumption has been passed was read, a warning message is displayed to an operator to call an attention to the operator. A POS system comprising: a bar code read means for reading a bar code attached to a sales commodity; a PLU storage means for storing commodity data such as commodity names of sales commodities and sales prices corresponding to the bar code; a display means for displaying commodity names and prices of sales commodities; a control means for getting access to the storage means when commodities are sold, specifying the commodities by the bar code of sales commodities, reading data relating to the commodity names of the commodities and the sales prices, displaying the commodity names and the prices of the commodities on the display means, and carrying out sales processing of the commodities; and a clock means, the control means recognizing that the sales commodity is a commodity subjected to management of the time of consumption on the basis of the bar code read by the bar code read means, comparing the time-of-consumption data included in the bar code with the present time from the clock means, and where the time-of-consumption data has passed the present time, displaying a warning thereof on the display means.

### TECHNICAL FIELD

The invention relates, in the time-of-consumption management of store-front sales commodities at a retail store, particularly in a POS (Point of Sale) system, to the POS system having a time-of-consumption management function of sales commodities by use of a bar code attached to the commodities.

### BACKGROUND ART

A commodity label is attached to a packed commodity in a supermarket or a convenience store; and in the store front, a bar code is read by a bar code reader connected to a POS terminal device such as a register to settle of accounts of the commodities purchased and to utilize also as management data such as sales management and commodity management. The commodity labels attached to the commodities are issued by a label printer connected to a computer or the like installed in a back yard (processing factory in a supermarket or a convenience store). As shown in FIG. 8, on the commodity label are printed characters of a commodity department code, a commodity name, a commodity read code, a charge, a time of consumption, and a time of consumption such as manufacture or processing date and time, and a bar code on which a commodity code is recorded.

Bar codes being used while being attached to normal commodities are a JAN (Japanese Article Number) code, and both a code system and figures are prescribed and standardized Further, a character code corresponding to the bar code is printed under the bar code. The bar code printed on the label in FIG. 8 shows a standard JAN bar code. This bar code is normally comprised a code of 13 figures, the first 2 figures being a country code, 5 figures from the 3rd to the 7th figure being a makers code, 5 figures from the 8th to the 12th figure being an item code, and the 13th figure being a check digit

A person in charge carries out checking of commodity stock in stores such as a supermarket or a convenience store by looking at commodities on the commodity shelves and counting the number of commodities. Particularly, with respect to the commodities for which freshness management is necessary, the time of consumption printed on the label attached to the commodity is checked to maintain quality thereof

However, in checking the commodities for which freshness management is particularly necessary m the commodity management, the person in charge looks at the time of consumption printed on the label attached to the commodity to carry out the management of commodities with the present date and time as a reference. As described above, because of the manual management of commodities, the person in charge sometimes overlooks the time of consumption, generating the circumstances that the commodities for which the time-of-consumption time has been already passed are present on the shelves.

Further, even the commodities for which the time of consumption is expired and where an operator does not become aware of it, the operator of the POS terminal device such as a register reads the bar code printed on the label by a bar code reader to settle accounts for those purchased.

On the bar code of the JAN Standard printed on the label, a makers code, a commodity code and so on are displayed, but the time of consumption and the time are not displayed. Because of this, the commodities whose time of consumption has been passed would be sold to customers unless the operator of the POS terminal device (a register for commodities) becomes aware of it.

Particularly, processed food (rice balls, lunches or the like) for which freshness maintenance is necessary have a possibility of giving rise to food poisoning in terms of food hygiene, and severe management therefore has been demanded. In the stores for processing and selling commodities for which freshness management is required, the risk, in case where commodities whose time of consumption has been passed had been sold, is extremely great.

In the present invention, when a commodity label is prepared by a label printer in the processing factory when a commodity is processed, a commodity label including a bar code on which the time-of-consumption date and time are displayed is automatically prepared in the form of specification designated to a PLU master delivered from the head office to attach it to the commodity. And, when the commodities are sold at the store front, the time of consumption and the time stored in the bar code can be checked automatically by the POS terminal device (register). An object of the invention is to provide a POS system having a time-of-consumption management function in which if the commodity whose time of consumption was read, a warning message is displayed for an operator to call attention.

### DISCLOSURE OF INVENTION

For achieving the aforementioned object, the present invention provides a POS system having a time-of-consumption management function of sales commodities, comprising: a bar code read means for reading a bar code attached to a sales commodity; a PLU (Primary Logical Unit) storage means for storing commodity data such as commodity names of sales commodities and sales prices corresponding to the bar code; a display means for displaying commodity names and prices of sales commodities; a control means for getting access to the storage means when commodities are sold, specifying the commodities by the bar code of sales commodities, reading data relating to the commodity names of the commodities and the sales prices, displaying the commodity names and the prices of the commodities on the display means, and carrying out sales processing of the commodities; and a clock means.

The control means in the present invention recognizes that the sales commodity is a commodity subjected to management of the time of consumption on the basis of the bar code read by the bar code read means, and the time-of-consumption data included in the bar code is compared with the present time from the clock means, and where the time-of-consumption data has passed the present time, a warning thereof is displayed on the display means.

Further, the bar code comprises a flag code, a commodity code, a bar code including a time code, and a check code applied corresponding to each of said codes, and the control means of the POS system recognizes that sales commodity is a commodity subject to management of the time of consumption from the flag code, specifies the commodity from the commodity code, and recognizes the time of consumption of the commodity from the time code. And the bar code comprises a code representative of a decimal number of 13 figures in total, the flag code is represented by the first 2-figure decimal code, the commodity code is represented by the next 6-figure decimal code, said time code is represented by the next 4-figure decimal code, and the check code is represented by the last 1-figure decimal code.

The decimal code of 4 figures showing said time code of the bar code comprises: a decimal code of 2 figures representative of a date of the time of consumption, and a decimal code of 2 figures representative of the time of the time of consumption. However, with respect to the commodity which requires no time management, the decimal code of 4 figures may be used as a code representative of all dates.

The decimal code of 2 figures representative of the date of the time of consumption is a Julian date continuously applied with a calendar date or a specific date as the first date.

The POS system in the present invention comprises a plurality of POS terminal devices and a central data processing unit, and the PLU storage means is arranged within the central data processing unit. And the display device comprises a display device for a client in the POS terminal device and a display device for an operator, and the warning display is displayed on the display device for an operator.

The POS terminal device is so constituted that the commodity relating to the warning display is not subjected to registration processing as sales commodity.

Further, the present invention provides a POS system having a time-of-consumption management function of sales commodities comprising: a commodity code management device for unitedly managing a commodity code for specifying commodities to be handled; a commodity label printing device for printing and outputting a bar code comprising a flag code showing, along with commodity information of commodities relating to the commodity code applied by the commodity code management device, that the commodities are commodities subjected to management of the time of consumption, a commodity code for specifying the commodities, a bar code including a time code for displaying the time of consumption of the commodities, and a check code applied corresponding to each of said codes; and a POS terminal device so constituted that on the basis of the bar code printed by the commodity label printing device, recognition is made that sales commodity is a commodity subjected to management of the time of consumption, time-of-consumption data included in the bar code is compared with the present time, and where the time-of-consumption data has passed the present time, a warning display thereof is made on the display means.

The bar code according to the present invention comprises a flag code, a commodity code, a bar code including a time code, and a check code applied corresponding to each of the codes, and the POS terminal device recognizes that sales commodity is a commodity subject to management of the time of consumption from the flag code, specifies the commodity from the commodity code, and recognizes the time of consumption of the commodity from the time code.

A department code, a commodity name, a sales price, date and time of manufacture or processing, the time of consumption and the like are printed on the commodity label.

Further, the commodity code management device, the commodity label printing device and the POS terminal device are connected mutually by a communication line, and the commodity code, the commodity information corresponding to the commodity code, and data relating to the bar code are transmitted through the communication line.

The commodity information and the bar code are read from the commodity code management device on the basis of the bar code, and printed by the commodity label printing device.

The time of consumption displayed on the bar code is counted from the manufacture time or processing time of the commodity on the basis of the kind of the commodities and the time data determined every kind of the commodities, automatically computed and printed.

### Brief Description of Drawings

FIG. 1 is a general view of the entire POS system in an example of the time-of-consumption management POS system according to the present invention.

FIG. 2 is a general block diagram of a label printer according to the present invention.

FIG. 3 is a general block diagram of a master POS terminal device according to the present invention.

FIG. 4 is a general block diagram of a POS terminal device 2 according to the present invention.

FIGS. 5 (a)-(c) show examples of contents of a record of a PLU master according to the present invention. FIG. 5 (a) shows a PLU master record of the goods for which freshness management is necessary in a PLU master management division ‘0’, FIG. 5 (b) shows a PLU master record of the goods using a standard JAN code 13-figures in a PLU master management division ‘1’, and FIG. 5 (c) shows a PLU master record of the goods using a standard JAN code 8-figures in a PLU master division ‘2’.

FIG. 6 shows an example of labels printed by a label printer 11 according to the present invention.

FIGS. 7 (a)-(b) show examples of the constitution of a bar code according to the present invention. FIG. 7 (a) shows a bar code printed on a label, and FIG. 7 (b) is a view for explaining the constitution of the bar code shown in FIG. 7 (a).

FIG. 8 shows a label attached to the goods in prior art.

### Best Mode for Carrying Out the Invention

The embodiments of the present invention will be described hereinafer with reference to the drawings.

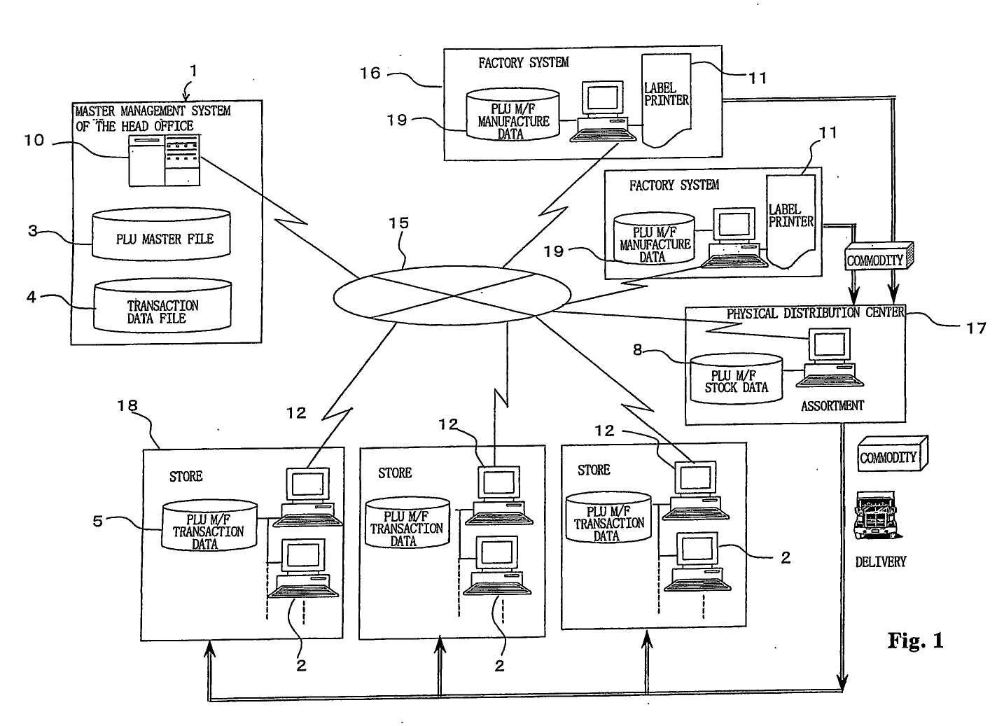

FIG. 1 is a general view of the entire POS system in an example of a quality maintenance management POS system according to the present invention. A master management system 1 of the head office comprises a commodity code management device 10, a PLU master file 3 of all stores connected to the commodity code management device 10, a transaction data file 4, relative data thereof, and a communication control device, etc. The commodity code management device 10 in the master management system 1 of the head office has a CPU (Central Processing Unit) for storing programs relating to application of the system, a storage device, and a communication control device, maintains and manages various files such as a PLU master file (M/F), and performs, through a network 15, instructions relating to processing of commodities to the factory, instructions to a physical distribution center for managing the physical distributions such as the grasping of actual results relating to the processing, stocks of commodities received and delivery to stores, various instructions relating to the send and receive of data with respect to stores 18, and the send and receive of data.

The network 15 used here may be a public network or an exclusive-use line, and the procedure is in accordance with the standard communication procedure such as a well-known TCP/IP procedure, not caring about the standard of the procedure.

A factory system 16, a physical distribution center system 17, and a plurality of central data processing units 12 of stores are connected to the master management system 1 of the head office through the network 15.

The factory system 16 connected to the master management system 1 of the head office through the network comprises a computer having at least a CPU and a communication function, a file device 19 connected to the computer, and a label printer 11.

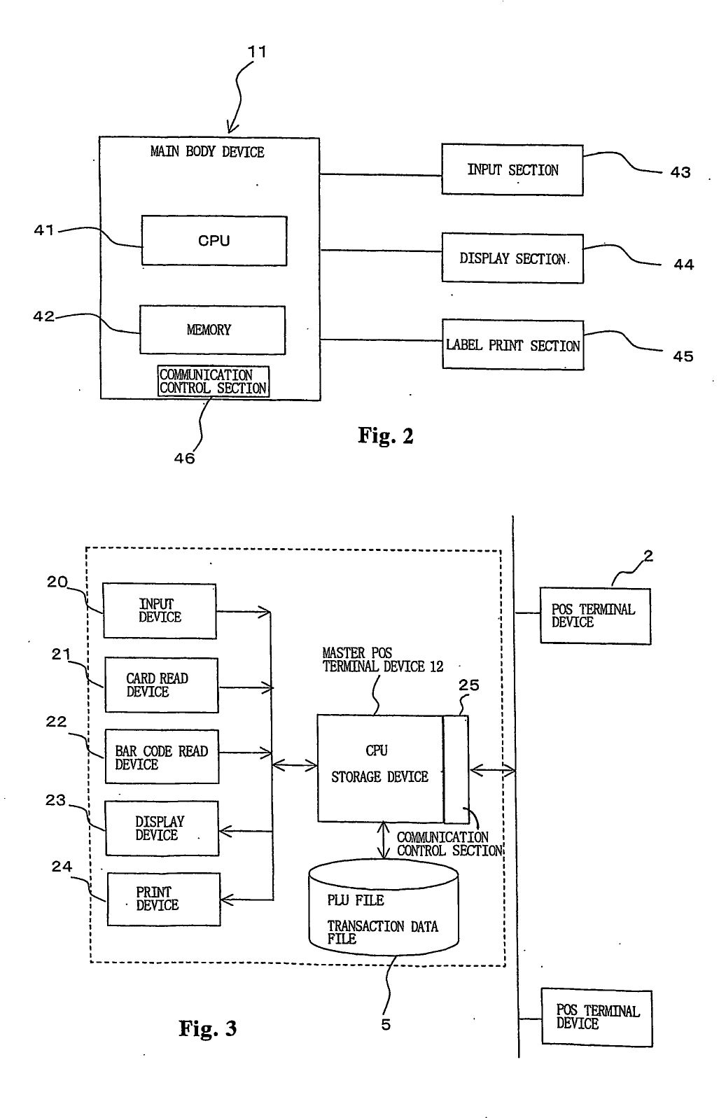

FIG. 2 is a general constitutional view of the label printer 11 according to the present embodiment. The label printer 11 has, in the main body apparatus, a CPU 41 including a clock mechanism, a memory 42 for storing programs or data, and a communication control section for controlling data communication, and comprises an input section 43 for inputting commodity code data, a display section 44 for displaying label data of commodities, and a label printing section 45 for printing letters and bar codes on the label, which are connected to the main body apparatus.

The physical distribution center system 17 of the physical distribution center comprises at least a CPU, a computer having a communication function, and a file device 8 (PLU M/F and data of stocks) connected to the computer.

Further, the system of each store comprises a central data processing unit 12 having a function serving as a CPU, a communication function, a file device and a store controller, and one or plurality of POS terminal devices 2. The central data processing unit 12 has a file device 5 for storing a PLU master file, transaction data and so on.

The central data processing unit 12 and the POS terminal device 2 are shown here in a general block diagram.

FIG. 3 is a general block diagram of the central data processing unit 12. The central data processing unit 12 comprises an input device 20 for inputting commodity codes, quantities and the like, a card read device 21 for reading cards such as a member's card and a credit card, a bar code read device 22 for reading a bar code attached to the commodities, a display device 23 for displaying names of commodities, the number of sales, prices, discount prices, and communication conditions, a printing device 24 for printing transaction data and issuing a receipt, a file device 5 for storing data such as a PLU file and a transaction file, a CPU for executing a control of these devices and a control of other POS terminal devices, and programs, a storage device for storing business programs and various data, a clock means, and a communication control section 25 for carrying out communication through the network 15.

FIG. 4 is a general block diagram of the POS terminal device 2. The POS terminal device 2 comprises an input device 20 for inputting commodity codes, quantities and the like, a card read device 21 for reading cards such as a member's card and a credit card, a bar code read device 22 for reading a bar code attached to the commodities, a display device 23 for displaying names of commodities, the number of sales, prices, discount prices, and communication conditions, a printing device 24 for printing transaction data and issuing a receipt, a CPU for executing a control of these devices and programs, a storage device for storing business programs and various data, a clock means for controlling date and time, and a communication control section 26 for carrying out communication through the network 15.

Now, a description will be made of an embodiment, particularly, of a bar code printed on a commodity label, in the POS system having a time-of-consumption management function of commodities (for example, such as rice balls, daily dishes, and lunches) which are subjected to processing and cooking in the own factory, delivered to the stores and sold, and require freshness management in the present application.

The master management system 1 of the head office controls the master file management relating to various master files such as a PLU master file and the bar code in the POS system. Normally, the bar code attached to commodities uses JAN 13-figures or 8-figures which is a standard norm. However, even a bar code of a label attached to commodities such as processed food which requires time-of-consumption management of selling commodities, data of the time-of-consumption cannot be displayed in the standard JAN code system. So, in the embodiment of the present invention, a bar code system for displaying data of date and time on a 13-figure bar code was added. A new management system was also employed for the PLU master file corresponding to the aforementioned bar code system.

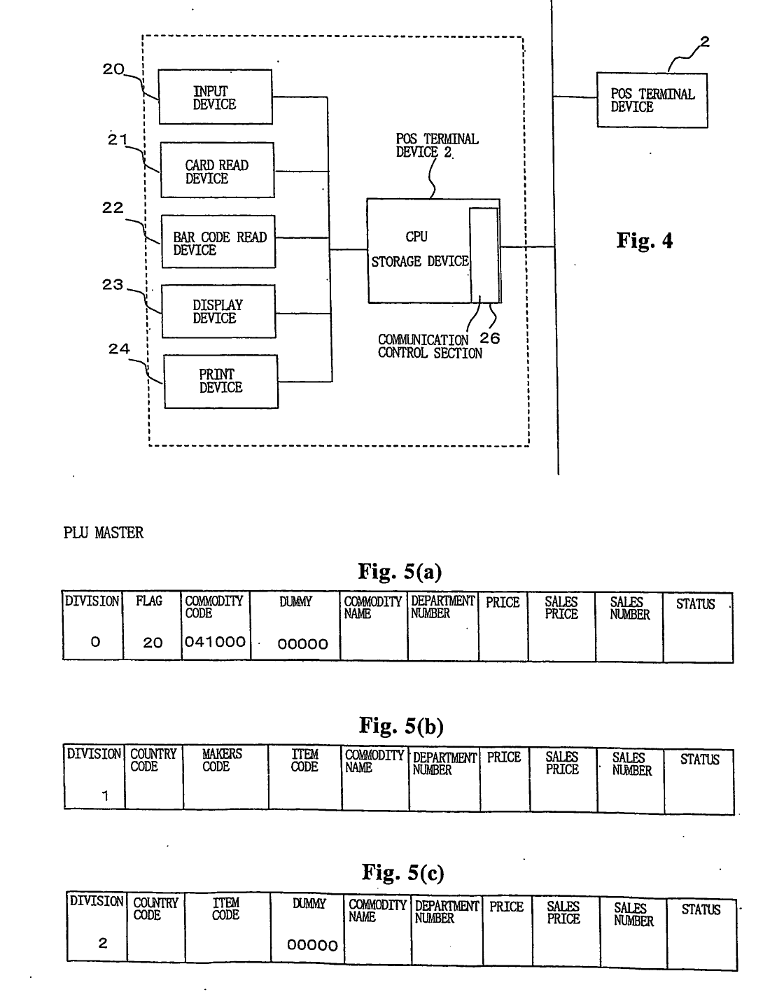

FIGS. 5 (a)-(c) show examples of the content of record of the PLU master file.

FIG. 5 (a) shows, where the PLU master file management division is ‘0’ and a flag is, for example, 20, a PLU master record of commodities which require freshness management (time-of-consumption management). Here, however, the flag may be, for example, 21 to 29 other than 20. The PLU master record consists of the division, flag, item code, dummy, commodity name, department number, price, sales price, number of sales, and call code.

FIG. 5 (b) shows, where the PLU master file management division is ‘1’, a PLU master record of commodities which use the standard JAN code 13-figures. The PLU master record consists of the division, country code, makers code, item code, dummy, commodity name, department number, price, sales price, number of sales, and call code.

FIG. 5 (c) shows, where the PLU master division is ‘2’, a PLU master record of commodities which use the standard JAN code 8-figures. The PLU master record consists of the division, country code, item code, dummy, commodity name, department number, price, sales price, number of sales, and call code.

The label printer 11 of the factory prepares commodity labels attached to the commodities according to the PLU master file.

FIG. 6 shows an example of a commodity label 30 printed by the label printer 11 in the present embodiment. Incidentally, while in the present embodiment, the figures of a bar code is 13, it is needless to say that the present invention can be also applied to a bar code of other figures (for example, 15 figures).

Now, a description will be made of an example of operation for preparing a commodity label on which the time-of-consumption is displayed. First, when a new commodity is developed and processing thereof is started, the master management system 1 of the head office prepares a PLU master including a PLU master file division corresponding to the commodity. After the PLU master file has been prepared by the PLU master management system 1 of the head office, the PLU master file is transmitted to the processing factory of the commodities. The factory system 16 receives the PLU master file transmitted from the head office and updates a PLU maser file 19 of the factory system 16. A person in charge who attaches a label to the processed commodity inputs a call code 31 of the commodity.

The factory system 16 calls a label printing record present in the PLU master file record divided by the flag 20 of the commodity record of the PLU master file corresponding to a code for calling the commodity. A code for a label called is sent to the label printer 11.

The label printer 11 connected to the factory system 16 label-prints data relating to the commodities on the basis of the label print record of the commodity read out. Then, the label is to be attached to the commodities.

Further, preparing of labels by the label printer 11 in the factory is carried out in the following procedure. In preparation of labels by the factory system 16 in the present embodiment, an exclusive-use call code 31 is provided every commodity in order to instruct the label printer 11 to print labels. When the call code 31 of the commodities is input into the label printer 11 installed in the place for the label attaching step which is the final step of processing, the factory system 16 calls the pertinent PLU master file.

Items necessary for label printing predetermined are read from the PLU master file of the commodities called to produce a label printing record. Then, the date and time at the time when the PLU file is called by the call code 31 of the commodity for label printing are specified as the commodity processing time of the commodity called. The factory system 16 computes the time of consumption on the basis of the specified date and time. In the computation of the time of consumption, the date and time of consumption is automatically computed counting from the manufacturing time or processing time of the commodities on the basis of the kinds of commodities and the time data determined every kind of commodities.

The computed data of the time of consumption are sent to the label printer 11 along with other print data of labels. The label printer 11 arranges a printing type including merchandise information and a bar code from data sent to produce a printing form on a print buffer.

The label printer 11 prints a commodity label 30 displaying thereon a bar code 35 displaying thereon date and time information designated by a flag 20 (commodities for which quality maintenance management is necessary) along with merchandise information printed on the label 30.

For example, for a commodity name “Rice ball” (32), a call code ‘281’ (31) is used. The flag of the PLU master file for the “Rice ball” (32) of the call code ‘281’(31) stored in the PLU master file is ‘20’, which is recognized as a commodity subjected to quality maintenance management. The factory system 16 specifies, when a call code ‘281’ (31) of commodity is input, its time.

The system performs the automatic computation counting from the manufacturing time or processing time of the commodities on the basis of the kinds of commodities and the time data determined every kind of commodities the above-specified time as a reference to calculate the date and time of the time of consumption. The factory system 16 sends data of the rice ball (commodity) and data for printing a label of the time of consumption to the label printer 11.

The label printer 11 having the data received prints characters of a call code 31, a commodity name 32, a sales price 33, a manufactured or processed date 36, a time of consumption 34 and the like, a flag code, a commodity code, a bar code on which the date of the time of consumption is displayed on the commodity label 30. While in the explanation of the present embodiment, the factory system 16 computes the time of consumption from the specified time, and sends the data of computed results to the label printer 11 as label printing data, it is to be noted that the label printer 11 may compute the time to automatically print it.

Commodity label data of the commodity label 30 printed by the label printer 11 and attached to the commodity is stored, for example, in the commodity shipment file or the like of the factory system 16 and transmitted to the head office.

An example of the bar code 35 having the time-of-consumption management function in the present invention is shown below.

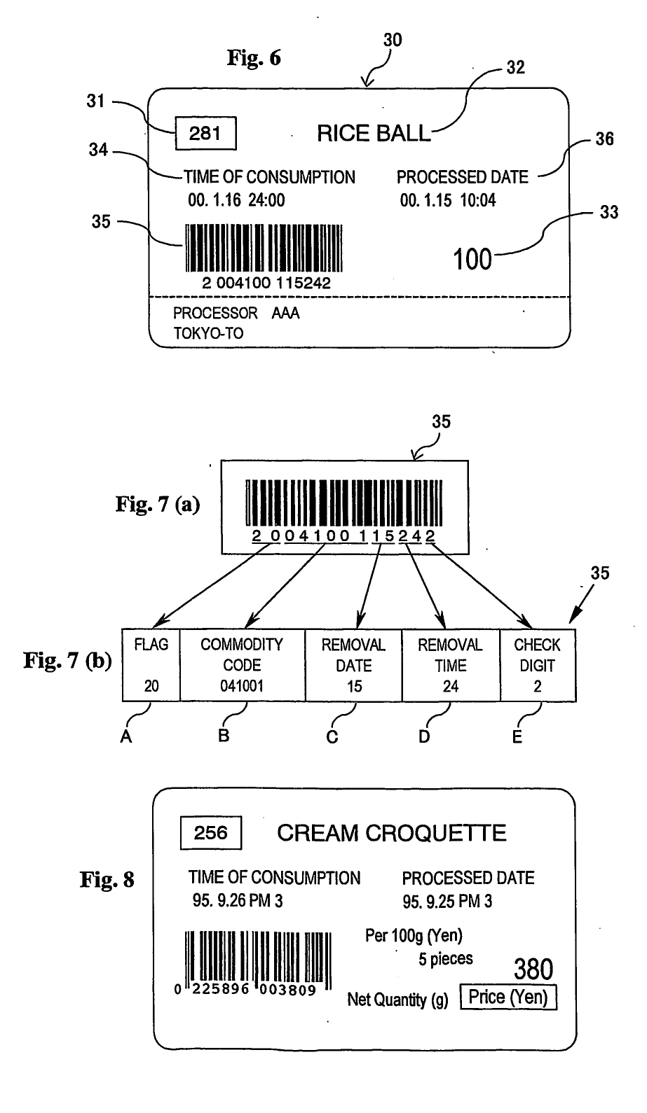

The bar code shown in FIG. 7 (a) shows an example of a bar code constituted by a code representative of decimal number of 13 figures on which the time of consumption is displayed. FIG. 7 (b) is a view for explaining the constitution of the bar code. As shown, 13 figures stored in the bar code are that the first 2 figures are a flag A, the next 6 figures from the 3rd figure to the 8th figure are a commodity code B, 2 figures of the 9th figure and the 10th figure are a time-of-consumption date C (hereinafter suitably called a removal date), the 11th figure and the 12th figure are a time-of-consumption time D (hereinafter suitably called a removal date), and the 13th figure is a check digit E applied corresponding to the respective codes.

The date of the time of consumption used in the bar code 35 is a Julian date, but a calendar date may be used. The Julian date is a date continuously applied with the specific date as the 1st date. In the present embodiment, the Julian date is 2 figures, from 00 to 99. For example, January 1 is 00 day, and April 11 is 99 days. And, April 12 is newly 00 day so as to manage the date. The time to be managed is a 24-time system.

The time of consumption 34 printed on the commodity label 30 by the label printer 11 in the procedure mentioned above in the processing factory is automatically computed and printed, and no error occurs. However, with respect to the commodity whose processing time zone is determined, it is also possible to prevent an erroneous issue in the procedure such that the label issuing time zone is check so that the label may not be printed at the time other than the processing time zone. For example, for boiled rice being processed and delivered three times (three deliveries) a day, the processing time zone is determined every delivery. In case where a call code of commodities of boiled rice is input at the time deviated from the processing time zone corresponding to the determined delivery, the processing time zone determined for commodities of boiled rice is compared with the input time of the call code 31, it is possible that the commodity label 30 may not be issued

Next, the commodities are delivered to the physical distribution center, and assorted toward the respective stores in the distribution center. At that time also, the bar code 35 is read to thereby enable checking of the label 30 of the commodity for which the quality maintenance management is necessary. The PLU master file has already been delivered also to the physical distribution system 17 from the head office by data communication. With respect to the commodities delivered from the factory, the bar code 35 of the label 30 attached to the commodity is read at the time of reception to carry out the commodity reception processing. The physical center system 17 carries out the reception processing by the latest PLU master file and the label data of commodities received.

At that time, the commodity label 30 of the commodity for which the time-of-consumption management is necessary and the date 34 of the time of consumption are checked to enable removing the commodities whose quality is disqualified from the delivery. Further, since the number of deliveries is determined in advance by the processing time zone, the commodities which are not in the time range of the number of deliveries can be removed as the commodities received by some mistake. And, in the physical distribution center system 17, sales commodity data are checked and assorted, after which the commodities are delivered to the respective stores.

Now, the management POS system having the time-of-consumption function at the time of store-front sales in the stores will be explained.

A customer takes the commodities purchased by the customer in the store to the place where the POS terminal 12 is installed, and a person in charge of sales (operator) carries out registration work for settlement of accounts. The registration operation is done by reading the bar code 35 printed on the commodity label 30 attached to the commodity, and calling, with the read commodity code B as a key, the pertinent commodity record of the PLUJ master file on the store side. Data necessary for settlement of accounts such as the commodity name and the price are taken into the POS terminal devices 2, 12 from the pertinent record of the PLU master file, and the settlement-of-accounts processing is carried out in accordance with the programs stored in the POS terminal devices 2, 12.

When the bar code reading device 22 read the bar code 35, the program first checks the first two figures of the bar code data. In the JAN standard 13-figures codes, two figures of the 1st figure and the 2nd figure are country codes. Normally, when a bar code is read, when the field of the country codes is a code other than the country codes predetermined, it is rejected to be read as error data. In the bar code system of the present system, there is prescribed that two figures corresponding to the country codes are used as a commodity flag (code) subjected to the time-of-consumption management. In the bar code of the commodities for which the time-of-consumption management is necessary in the present application, ‘20’ of the code in which two figures of the 1st figure and the 2nd figure are not reserved as the country codes is reserved. The constitutional example of the bar code 35 of the commodity for which the time-of-consumption management is necessary is as explained in the above-described FIGS. 7 (a)-(b).

The reading program on the side of the POS terminal device 2 reads the bar code on the commodity label 30. The read bar code data is judged to be the commodity whose first two figures are the flag ‘20’ and for which the time-of-consumption management is necessary, and the reading processing of the bar code constitution of the flag ‘20’ (reading of a bar code format of the commodity for which the time-of-consumption management is necessary) is carried out.

The time of consumption (removal date) of the bar code read and the time-of-consumption time (removal time) 34 are compared with the calendar and the clock at the time of reading held by the POS terminal device 2, and the date and time of the time-of-consumption are checked. The date and time of the time-of-consumption 34 are checked, and when the date and time of the time-of-consumption 34 have already been passed, a warning message to the effect that the time of consumption is expired is displayed merely on the display device 23 on the operator side.

It may be designed so that a warning is further issued. In accordance with the warning, the operator replaces the commodities with other commodities within the time of consumption to sell them. Further, a program may be prepared so that registration of the commodities whose the time of consumption is expired cannot be made. The commodity data whose the time of consumption is expired read at the time of registration are temporarily stored in the storage device as the commodity data whose the time of consumption is expired, and processing of abandonment and data processing of abandonment are carried out.

After the check processing, normal registration work is continuously carried out, purchase information is printed on a receipt, and the receipt is issued. The sales and abandonment data of the registered commodities are transmitted to the master management system 1 of the head office through a communication line. Since the data whose the time of consumption is expired can be grasped positively as described above, the reliability of the commodity management and the abandonment commodity management increases.

As explained above in detail, in the present invention, the label 30 attached to the commodity in synchronous with the time when the commodity is processed in the commodity processing site is prepared, and in the label 30, the time-of-consumption data and time 34 are calculated with the processed date and time as a reference to display them on the bar code 35. Then, where the commodity whose the time of consumption has been passed was read, the POS terminal device issues a warning message or an alarm to call an attention. The operator can exchange the commodity whose the time of consumption has been passed in accordance with the warning to thereby realize the complete prevention from selling the commodities whose the time of consumption is expired.

Further, in the management of the store-front commodities, even the same commodities, the number of deliveries every delivery date and every delivery, and the quantities every sales date and time and every abandonment date and time can be grasped to facilitate a predication of stocking and sales management

1. A POS system having a time-of-consumption management function of sales commodities, comprising:
a bar code read means for reading a bar code attached to a sales commodity;
a PLU (Primary Logical Unit) storage means for storing commodity data such as commodity names of sales commodities and sales prices corresponding to said bar code;
a display means for displaying commodity names and prices of sales commodities;
a control means for getting access to said storage means when commodities are sold, specifying the commodities by said bar code of sales commodities, reading data relating to the commodity names of the commodities and the sales prices, displaying the commodity names and the prices of the commodities on said display means, and carrying out sales processing of the commodities; and
a clock means, characterized in that
said control means recognizes that the sales commodity is a commodity subjected to management of the time of consumption on the basis of the bar code read by said bar code read means, and
the time-of-consumption data included in the bar code is compared with the present time from said clock means, and where said time-of-consumption data has passed the present time, a warning thereof is displayed on said display means.

2. The POS system according to claim 1, wherein said bar code comprises a flag code, a commodity code, a bar code including a time code, and a check code applied corresponding to each of said codes, and
said control means of the POS system recognizes that sales commodity is a commodity subject to management of the time of consumption from said flag code, specifies said commodity from said commodity code, and recognizes the time of consumption of said commodity from said time code.

3. The POS system according to claim 2, wherein said bar code comprises a code representative of a decimal number of 13 figures in total, said flag code is represented by the first 2-figure decimal code, said commodity code is represented by the next 6-figure decimal code, said time code is represented by the next 4-figure decimal code, and said check code is represented by the last 1-figure decimal code.

4. The POS system according to claim 3, wherein the decimal code of 4 figures showing said time code comprises:
a decimal code of 2 figures or 4 figures representative of a date of said time of consumption, and
a decimal code of 2 figures representative of the time of said time of consumption where the decimal code representative of the date of said time of consumption is 2 figures.

5. The POS system according to claim 4, wherein the decimal code of 2 figures representative of the date of said time of consumption is a Julian date continuously applied with a calendar date or a specific date as the first date.

6. The POS system according to claim 1, wherein said POS system comprises a plurality of POS terminal devices and a central data processing unit, and said PLU storage means is arranged within said central data processing unit.

7. The POS system according to claim 6, wherein said display device comprises a display device for a client in the POS terminal device and a display device for an operator, and said warning display is displayed on said display device for an operator.

8. The POS system according to claim 6, wherein said POS terminal device is so constituted that the commodity relating to said warning display is not subjected to registration processing as sales commodity.

9. A POS system having a time-of-consumption management function of sales commodities comprising:
a commodity code management device for unitedly managing a commodity code for specifying commodities to be handled;
a commodity label printing device for printing and outputting a bar code comprising a flag code showing, along with commodity information of commodities relating to the commodity code applied by said commodity code management device, that said commodities are commodities subjected to management of the time of consumption, a commodity code for specifying said commodities, a bar code including a time code for displaying the time of consumption of said commodities, and a check code applied corresponding to each of said codes; and
a POS terminal device so constituted that on the basis of said bar code printed by said commodity label printing device, recognition is made that sales commodity is a commodity subjected to management of the time of consumption, time-of-consumption data included in said bar code is compared with the present time, and where said time-of-consumption data has passed the present time, a warning display thereof is made on said display means.

10. The POS system according to claim 9 wherein said bar code comprises a flag code, a commodity code, a bar code including a time code, and a check code applied corresponding to each of said codes, and
said POS terminal device recognizes that sales commodity is a commodity subject to management of the time of consumption from said flag code, specifies said commodity from said commodity code, and recognizes the time of consumption of said commodity from said time code.

11. The POS system according to claim 9 wherein a department code, a commodity name, a sales price, date and time of manufacture or processing, the time of consumption and the like are printed on said commodity label.

12. The POS system according to claim 9 wherein said commodity code management device, said commodity label printing device and said POS terminal device are connected mutually by a communication line, and
said commodity code, said commodity information corresponding to the commodity code, and data relating to said bar code are transmitted through said communication line.

13. The POS system according to claim 12 wherein said commodity information and said bar code are read from said commodity code management device on the basis of said bar code, and printed by said commodity label printing device.

14. The POS system according to claim 13 wherein said time of consumption displayed on said bar code is counted from the manufacture time or processing time of said commodity on the basis of the kind of the commodities and the time data determined every kind of said commodities, automatically computed and printed.
